(19) United States
(12) Patent Application Publication
(10) Pub. No.: US 2017/0142157 A1
(43) Pub. Date: May 18, 2017

(54) OPTIMIZATION OF CLOUD COMPLIANCE SERVICES BASED ON EVENTS AND TRENDS

(71) Applicant: INTERNATIONAL BUSINESS MACHINES CORPORATION, Armonk, NY (US)

(72) Inventors: Bin CAO, Stanford, CA (US); David M. EGLE, Rochester, MN (US); Daniel L. HIEBERT, Pine Island, MN (US); Yongwen WU, Rochester, MN (US)

(21) Appl. No.: 14/940,742

(22) Filed: Nov. 13, 2015

(51) Int. Cl. H04L 29/06

(52) U.S. Cl. CPC H04L 63/20

(57) ABSTRACT

A computer-implemented method includes: monitoring, by a computing device, compliance-related event information by periodically or intermittently receiving the compliance-related event information via an application programming interface (API) of the computing device; detecting, by the computing device, an event trigger or multiple event triggers based on monitoring the compliance-related event information; performing, by the computing device, a compliance check, in accordance with a compliance checklist, on an endpoint associated with a cloud network based on detecting the event trigger; receiving, by the computing device, results to the compliance check; and updating, by the computing device, the compliance checklist based on the results of the compliance check.

### BACKGROUND

The present invention generally relates to cloud compliance checks, and more particularly, to optimization of cloud compliance checks based on events and trends.

The advent of cloud computing has changed the way businesses utilize computing resources within their industries. Cloud computing is computing in which large groups of remote servers are networked together for centralized data storage and online access to services or resources. In essence, cloud computing pools resources and controls their availability through virtualization technologies. Cloud computing architectures implement virtual machines (VMs) to create different virtual environments supporting different services.

Cloud managed services is the advanced management of the virtualized endpoints. Cloud managed services is becoming more prevalent in the public, private, and hybrid cloud markets as a way to ensure the virtualized workloads meet certain operating standards. Cloud managed services brings the idea of setting up services such as Anti-Virus, Backup, Disaster Recovery, Monitor, Health-Check, Patch, Security and other services to virtualized servers or VMs to ensure their stability, security, and performance. Cloud managed services focuses on maintaining the operations of VMs implemented by a cloud computing network. If cloud is about “create, delete, start, stop and restart” of a VM, then cloud managed services is everything about what happens once a VM is running.

Cloud managed services also includes the implementation of compliance services, or software services that administers ‘compliance checks’ on VMs. Compliance is a concept that the VMs adhere to a set of policies and reliability/performance standards. Certain tools built to specific criteria have been brought forward from the “private data” center as part of compliance checks. These tools are manual and labor intensive and lack basic automation. An example of such a tool is one that requires manual intervention on deploy, or a tool that runs only at deploy time/destroy time and does not get updated at regular intervals.

Problems occur when applying cloud managed services generically to larger numbers of virtualized servers. Some clouds may have as many as tens of thousands of VM's running across several sites, with perhaps thousands per site, and each managed service is working in isolation achieving the necessary goals to ensure the correct policies are adhered to across the cloud, (i.e., compliance). When compliance checks are run, they can be time consuming, network intensive and resource constraining.

### SUMMARY

In an aspect of the invention, a computer-implemented method includes: monitoring, by a computing device, compliance-related event information by periodically or intermittently receiving the compliance-related event information via an application programming interface (API) of the computing device; detecting, by the computing device, an event trigger or multiple event triggers based on monitoring the compliance-related event information; performing, by the computing device, a compliance check, in accordance with a compliance checklist, on an endpoint associated with a cloud network based on detecting the event trigger; receiving, by the computing device, results to the compliance check; and updating, by the computing device, the compliance checklist based on the results of the compliance check.

In another aspect of the invention, there is a computer program product for optimizing compliance check services, the computer program product comprising a computer readable storage medium having program instructions embodied therewith. The program instructions are executable by a computing device to cause the computing device to: monitor compliance-related event information by periodically or intermittently receiving the compliance-related event information via an application programming interface (API) of the computing device; detect an event trigger or multiple event triggers based on monitoring the compliance-related event information; perform a compliance check, in accordance with a compliance checklist, on an endpoint associated with a cloud network based on detecting the event trigger; receive results to the compliance check; and update one or more of the plurality of event triggers based on the results of the compliance check.

In another aspect of the invention, a system includes: a CPU, a computer readable memory and a computer readable storage medium associated with a computing device; program instructions to monitor compliance-related event information by periodically or intermittently receiving the compliance-related event information via an application programming interface (API) of the computing device; program instructions to detect a time trigger of multiple time triggers, or an event trigger of multiple event triggers based on monitoring the compliance-related event information; program instructions to perform a compliance check, in accordance with a compliance checklist, on an endpoint associated with a cloud network based on detecting the time trigger or the event trigger; program instructions to receive results to the compliance check; program instructions to update the compliance checklist based on the results of the compliance check; program instructions to update one or more of the multiple time triggers based on the results of the compliance check; and program instructions to update one or more of the multiple event triggers based on the results of the compliance check. The program instructions are stored on the computer readable storage medium for execution by the CPU via the computer readable memory.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows an overview of an example implementation in accordance with aspects of the present invention.

FIG. 5 shows an example flowchart for updating compliance checklists and triggers based on compliance results in accordance with aspects of the present invention.

FIG. 6 shows an example flowchart for updating compliance checklists and triggers based on changes to usage patterns and/or cloud configuration information in accordance with aspects of the present invention.

### DETAILED DESCRIPTION

The present invention generally relates to cloud compliance checks, and more particularly, to optimization of cloud compliance checks based on events and trends. In embodiments, the frequency and types of compliance checks that are run in a cloud environment may be dynamically adjusted throughout the lifecycles of cloud computing endpoints (e.g., virtual machines). For example, a compliance checklist identifying the frequency and types of compliance checks performed on various endpoints may be dynamically adjusted based on usage patterns, event information, results from compliance checks, and/or updates to cloud configurations (e.g., the addition or deletion of cloud entities, such as users, applications, virtual machines, etc., or the resizing of resources to the endpoint, such as CPU, memory, storage, etc.). Aspects of the present invention focuses on improving the Compliance Service for a managed cloud to ensure the end points remain compliant after they are activated. The idea of this invention is to implement a mechanism to trigger the execution of compliance services on the end point based on certain criteria. Furthermore, this mechanism can self-learn over time to fit the particular compliance need of the end point, or categories of end points. Aspects of the present invention may include the following processes: Define a set of criteria that will trigger the compliance service check; interject and or update the policies from the set of criteria based on specific cloud ecosystem patterns (user behavior, demand trends, upgrade/patch triggers); and based on the set of criteria and the policies, as cloud entities (application, VM, user, etc) are added and or removed, a mechanism to dynamically append or remove existing compliance policies and triggers to the changed cloud entity. A basis for further optimize policy triggers by comparing the criteria and policies with current cloud ecosystem behavior and potential trends. Advantageously, performance of cloud computing endpoints is improved as the frequency and types of compliance checks performed on the endpoints are adjusted based on the above factors.

Further, compliance check triggers that initiate compliance checks may also be dynamically adjusted, (e.g., based on usage patterns, event information, results from compliance checks, and/or updates to cloud configurations). In embodiments, usage patterns, event information, results from compliance checks, and/or updates to cloud configurations may themselves be used as triggers to initiate a compliance check.

In embodiments, default compliance checklists and triggers may be initially implemented, and these checklists and triggers may be continuously refined/adjusted over time (e.g., based on the above factors). For example, a particular checklist may identify the types of compliance checks to perform on a particular endpoint (e.g., virtual machine). A trigger may indicate when the compliance checks should be performed. In embodiments, triggers may be time based or event based. For example, compliance checks defined in a checklist may be performed at a particular time (e.g., in response to a time trigger) or after the occurrence of an event (e.g., in response to an event trigger). Different checklists may be triggered based on different events and time intervals (e.g., Checklist A is triggers only if events 1, 2, and 3 occur, whereas Checklist B is triggered only if events 1, 2, 3, and 4 occur).

As changes are made to the endpoint (e.g., as authorized users, applications, etc. are added and deleted, or as resources are resized for the endpoint), the checklist and triggers may be updated based on such changes. For example, compliance checks may be added to the checklist for newly installed applications, or deleted from the checklist for recently deleted applications. As another example, compliance checks may be added to the checklist for newly allocated resources (e.g., storage, memory, etc.). Also, triggers may be updated based on policies associated with the added or removed compliance checks.

Further, based on event information, the checklists may be updated to add or remove compliance checks. As an illustrative example, event information may indicate that an active virus has been detected on a particular application. For example, message board postings (e.g., electronic bulletin boards, blog posts, social medial posts, etc.), virus definitions, logs, and/or other event information may indicate that other users/administrators have encountered the virus. Based on this information, a checklist may be updated to add a virus check for the application to the checklist. Further, an event trigger may initiate the compliance check based on the event information indicating that an active virus has been detected.

In embodiments, the checklist may be modified based on usage patterns and trends. For example, the checklists may define a priority and/or schedule that identifies which compliance checks to perform at particular times. Information regarding the usage patterns and trends may be used to modify the checklist based on when various applications implemented by an endpoint are used. In embodiments, usage patterns and trends may trigger compliance checks.

In embodiments, results from compliance checks may be used to update checklists and/or triggers. For example, if particular compliance checks are routinely found to be non-compliant, these compliance checks may be classified as “high risk” compliance checks and may be prioritized higher than those compliance checks that are routinely found to be compliant (e.g., “low risk” compliance checks). Checklists may be redefined and subdivided based on their risk levels, and time-based triggers may be defined such that checklists with higher risk compliance checks are checked more often than checklists with lower risk compliance checks. Also, for areas that are often found to be non-compliant, additional compliance checks or questions can be added to the checklist to more thoroughly check the risky areas.

In embodiments, if a compliance check is triggered by an event, and the compliance check routinely indicates compliance, then that event trigger may be deleted, as the event has proven to be non-problematic over time. Alternatively, the trigger can be redefined so that the compliance check is triggered less often. In embodiments, if a compliance check is triggered by an event, and the compliance check routinely indicates non-compliance, then an additional event trigger may be added, or the event trigger may be redefined such that the compliance check is triggered more often.

In accordance with aspects of the present invention, compliance checks that are performed, and triggers that initiate these checks are adjusted based on past, current, and predicted future cloud environment actions. Advantageously, compliance checks are more robust and effective.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the flowchart illustrations, and combinations of blocks in the flowchart illustrations, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

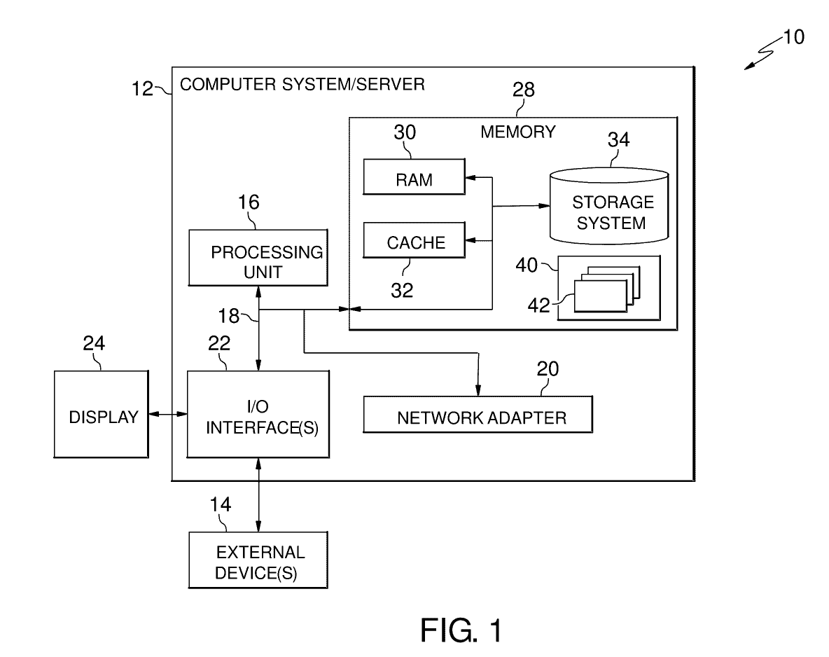

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

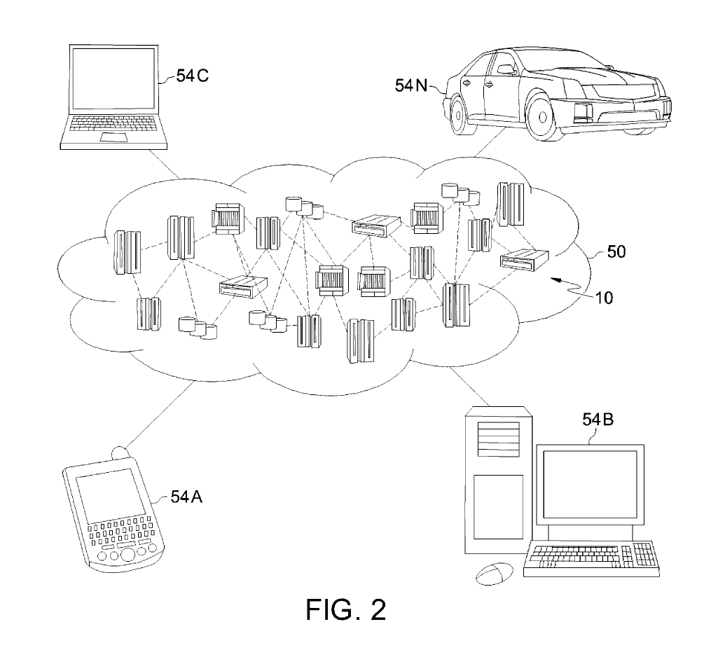

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

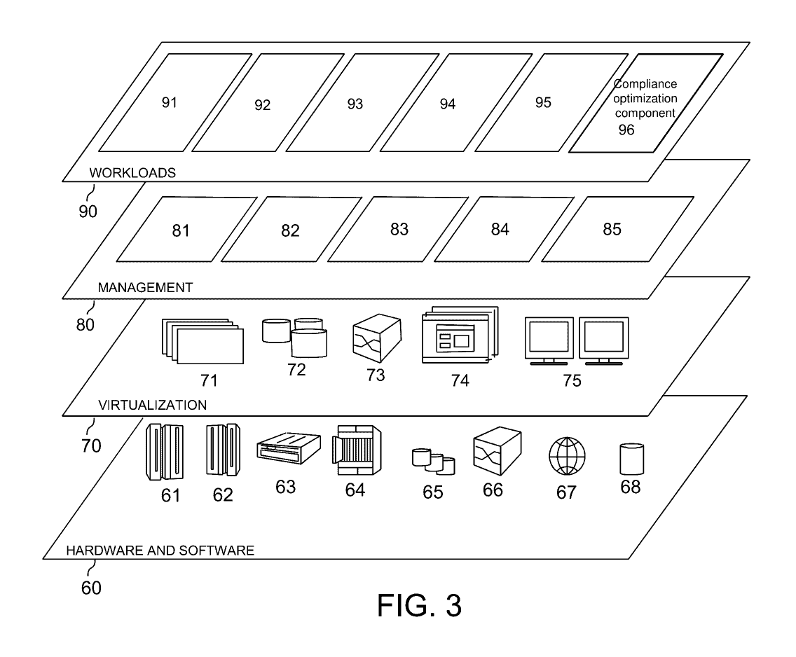

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and compliance optimization component 96.

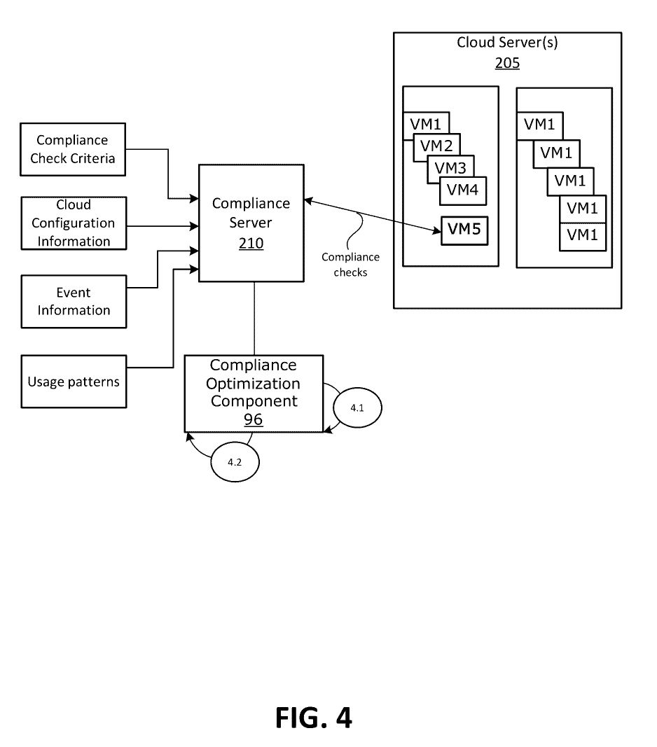

Referring back to FIG. 1, the Program/utility 40 may include one or more program modules 42 that generally carry out the functions and/or methodologies of embodiments of the invention as described herein. Specifically, the program modules 42 may monitor compliance related events and usage patterns, detect compliance check triggers based on the events and usage patterns, perform compliance checks, receive results to the compliance results, update compliance checklists and triggers based on the compliance check results, and notify an administrator of the updates and of the compliance check results. Other functionalities of the program modules 42 are described further herein such that the program modules 42 are not limited to the functions described above. Moreover, it is noted that some of the modules 42 can be implemented within the infrastructure shown in FIGS. 1-3. For example, the modules 42 may be representative of a parking selection server as shown in FIG. 4.

FIG. 4 shows an overview of an example implementation in accordance with aspects of the present invention. As shown in FIG. 4, cloud server(s) 205 implement multiple different virtual machines (VMs) over different regions (e.g., network regions or geographical regions). A compliance server 210 includes the compliance optimization component 96 of FIG. 3, which may be implemented as a program module 42, and which may generate and maintain an inventory of the culmination of compliance checks performed on the cloud server(s) 205 as described herein. The compliance server 210 may perform compliance checks with various endpoints (e.g., VMs) of the cloud server(s) 205. In the example of FIG. 4, the compliance check server 210 may perform compliance checks with VMS.

Prior to initially performing a compliance check, the compliance server 210 may receive compliance check criteria, and may further receive and monitor cloud configuration information, event information and/or usage patterns. The compliance check criteria may identify compliance checks to perform on the endpoint (e.g., VMS), and the triggers that initiate the compliance checks. The compliance check criteria may initially be default criteria, or defined by an administrator of a cloud network.

The cloud configuration information identifies the topology and/or architecture of a cloud network implemented by the cloud server(s) 205. For example, the cloud configuration information identifies the VMs, the functions of the VMs, services provided by the VMs, software implemented by the VMs, resources allocated to the VMs, etc.

The event information may include any information relating to the triggering of compliance checks. For example, the event information may be information from activity logs (e.g., logs indicating the changing of settings, such as firewall settings, logs indicating the addition of new users or the modification of software installation patterns, etc.), social media networks, blog or message board posts, virus definition alerts, software manufacturer update reports, and/or other messages/alerts that relate to events concerning the initiation of compliance checks.

The usage patterns may include information identifying usage activity for the endpoints (e.g., application usage activity, etc.). The usage patterns and event information may be related in that usage patterns may trigger the initiation of a compliance check (e.g., based on an event trigger).

As further shown in FIG. 4, the compliance optimization component 96 may define compliance checklists and trigger for the endpoint (at step 4.1). The compliance checklists and triggers may initially be defined based on default compliance checklist criteria and based on an initial cloud configuration (e.g., applications implemented by the VM and resources dedicated to the VM). As described above, the compliance checklist may identify particular compliance checks to perform on the checklist. The triggers may include time-based triggers that indicate intervals (e.g., daily, weekly, monthly intervals) for when to perform the compliance checks. Additionally, or alternatively, the triggers may include event-based triggers that indicate that the checks should be performed based on the occurrence of an event (e.g., after receiving an alert or message indicates the possible presence of a virus, after certain settings have been changes, such as firewall settings, after changes have been made to the endpoint, etc.).

As further shown in FIG. 4, the compliance server 210 may perform compliance checks with the endpoint. For example, the compliance server 210 may perform the compliance checks defined in the checklist In embodiments, the compliance server 210 may perform the compliance checks based on the triggering of a time-based or event-based trigger. Alternatively, the compliance server 210 may perform the compliance checks based on receiving a manual instruction for an administrator.

In embodiments, the compliance optimization component 96 may update the compliance checklist and the triggers based on the results of the compliance checks (at step 4.2). Further the compliance optimization component 96 may update the compliance checklist and the triggers based on monitoring the cloud configuration information, the event information and/or the usage patterns, as described above. For example, if particular compliance checks are routinely found to be non-compliance alerts, these compliance checks may be classified as “high risk” compliance checks and may be prioritized higher than those compliance checks that are routinely found to be compliant (e.g., “low risk” compliance checks). Checklists may be redefined and subdivided based on their risk levels, and time-based triggers may be defined such that checklists with higher risk compliance checks are checked more often than checklists with lower risk compliance checks. Also, for areas that are often found to be non-compliant, additional compliance checks or questions can be added to the checklist to more thoroughly check the risky areas.

Further, based on event information, the checklists may be updated to add or remove compliance checks. As an illustrative example, event information may indicate that an active virus has been detected on a particular application. For example, blog posts, virus definitions, logs, and/or other event information may indicate that other users/administrators have encountered the virus. Based on this information, a checklist may be updated to add a virus check for the application to the checklist. Further, an event trigger may initiate the compliance check based on the event information indicating that an active virus has been detected. In this way, the event information is not only is used to initiate a compliance check based on an event-based trigger, but may also be used to modify the compliance checklist (e.g., to add checks for virus and/or other items that may not have been previously on the checklist).

In embodiments, the compliance optimization component 96 may monitor the cloud configuration information for the endpoint (e.g., by receiving updates to the cloud configuration information from an administrator of the endpoint). The compliance optimization component 96 may update the compliance checklist based on these updates. For example, compliance checks may be added to the checklist when for newly installed applications, or deleted from the checklist for recently deleted applications, etc. Additionally, or alternatively, compliance checks may be added for newly added storage or other resources recently allocated to the endpoint.

In embodiments, the compliance optimization component 96 may monitor the usage patterns and user activity, and may update the checklists and/or triggers based on the usage patterns. For example, the checklists may define a priority and/or schedule that identifies which compliance checks to perform at particular times. Information regarding the usage patterns and trends may be used to modify the checklist based on when various applications implemented by an endpoint are used. In embodiments, usage patterns and trends may trigger compliance checks. Also, the compliance checklist may be modified when settings on the endpoints are changed (e.g., a compliance check may be added to check a newly added or modified firewall).

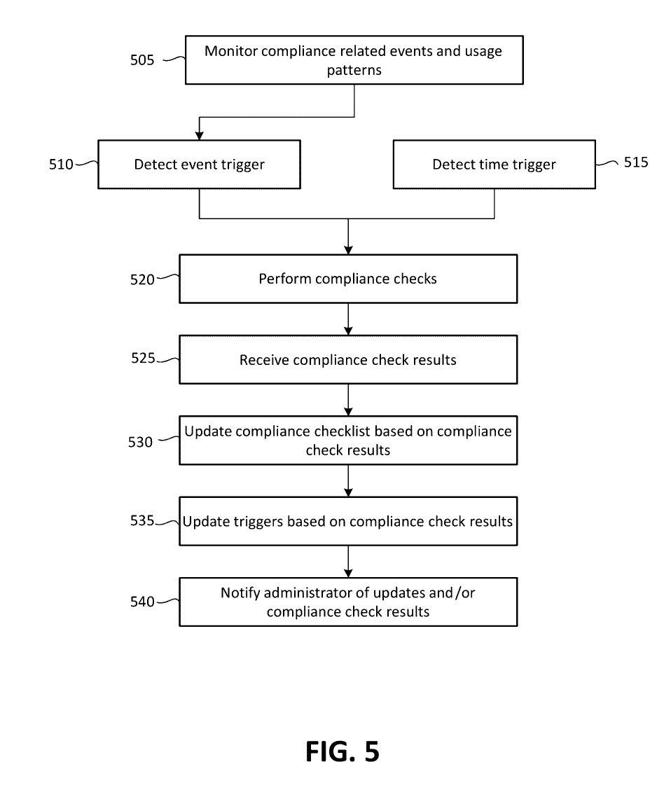

FIG. 5 shows an example flowchart for updating compliance checklists and triggers based on compliance results in accordance with aspects of the present invention. The steps of FIG. 5 may be implemented in the environment of FIGS. 1-3, for example, and are described using reference numbers of elements depicted in FIGS. 1-3. As noted above, the flowchart illustrates the architecture, functionality, and operation of possible implementations of systems, methods, and computer program products according to various embodiments of the present invention.

At step 505, compliance related events and usage patterns are monitored. For example, the compliance server 210 may monitor the compliance related event and usage patterns by using an API to periodically and/or intermittently receive event information relating to compliance checks. For example, the compliance server 210 may monitor information from internal or external sources, such as internal or external message boards, alert repositories maintained by service providers (e.g., virus protection service providers), social media networks, etc. relating to compliance events. Further, the compliance server 210 may monitor activity logs identifying usage activity of endpoints in a cloud component.

At step 510, an event trigger is detected. In embodiments, the compliance server 210 may detect an event trigger based on keywords or phrases present in messages (e.g., from message boards, social media networks, alert messages from a virus protection service provider, etc.). For example, the compliance server 210 may detect the event trigger based on keywords or phrases indicating a virus warning. Additionally, or alternatively, the compliance server 210 may detect the event trigger based on usage patterns, such as updates to certain settings. Additionally, or alternatively, the compliance server 210 may detect the event trigger based on the occurrence of another event. As described herein, the compliance server 210 may perform compliance checks in response to the event trigger. In embodiments, different compliance checks may be performed with different endpoints based on different event triggers.

At step 515, a time trigger is detected. For example, the compliance server 210 may detect a time trigger when a compliance check is due. As described above, the time triggers may be initially defined based on default compliance check criteria. The time triggers may reset such that compliance checks are performed at periodic intervals.

At step 520, compliance checks are performed. For example, the compliance server 210 may perform the compliance checks identified in a compliance checklist based on the detection of an event or time trigger. The compliance server 210 may perform compliance checks with the endpoints associated with the event and time triggers. For example, as described above, the compliance server 210 may perform different compliance checks with different endpoints based on different event and time triggers. As an illustrative example, if a compliance check was performed in response to an event trigger associated with a virus check (e.g., when a virus warning or alert was posted on a message board), the compliance checklists may include virus checks at various areas of an endpoint. As another illustrative example, if a compliance check was performed in response to an event trigger associated with a settings change (e.g., when a user modified firewall settings), the compliance checklists may include security checks at various areas of an endpoint.

At step 525, compliance check results are received. For example, the compliance server 210 may receive compliance check results based on performing the compliance checks with the endpoints. In embodiments, the results may further indicate entities or areas of an endpoint that were checked (e.g., applications, resources, scripts, images, etc.), and whether the checks were compliant or non-compliant. Further, the results may identify the types of checks performed (e.g., virus checks, security compliance checks, performance compliance checks, resource compliance checks etc.).

At step 530, compliance checklists are updated based on the compliance check results. In embodiments, the compliance server 210 may update the compliance checklists. For example, if particular compliance checks are routinely found to be non-compliant, these compliance checks may be classified as “high risk” compliance checks and may be prioritized higher than those compliance checks that are routinely found to be compliant (e.g., “low risk” compliance checks). Checklists may be redefined and subdivided based on their risk levels, and time-based triggers may be defined such that checklists with higher risk compliance checks are checked more often than checklists with lower risk compliance checks. Also, for areas that are often found to be non-compliant, additional compliance checks or questions can be added to the checklist to more thoroughly check the risky areas.

At step 535, triggers are updated based on compliance check results. In embodiments, the compliance server 210 may update the triggers based on the compliance check results. For example, if a compliance check is triggered by an event, and the compliance check results routinely show compliance, then that event trigger may be deleted, as the event has proven to be non-problematic over time. Alternatively, the trigger can be redefined so that the compliance check is triggered less often. In embodiments, if a compliance check is triggered by an event, and the compliance check routinely indicates non-compliance, then an additional event trigger may be added, or the event trigger may be redefined such that the compliance check is triggered more often. In this way, the checklist and triggers are continuously updated based on self-learning and monitoring of compliance related events and usage patterns, such that the checklist and triggers are better suited for an endpoint as compliance related events and usage patterns are monitored. This may further save time and improve compliance checking efficiencies and compliance results over time.

At step 540, an administrator may be notified of the updates and/or of the compliance check results. For example, the compliance server 210 may output or display a message that notifies an administrator of the updated compliance checklists and/or triggers. Further, the administrator may be notified of the compliance check results with an alert for those compliance checks that identified non-compliant areas.

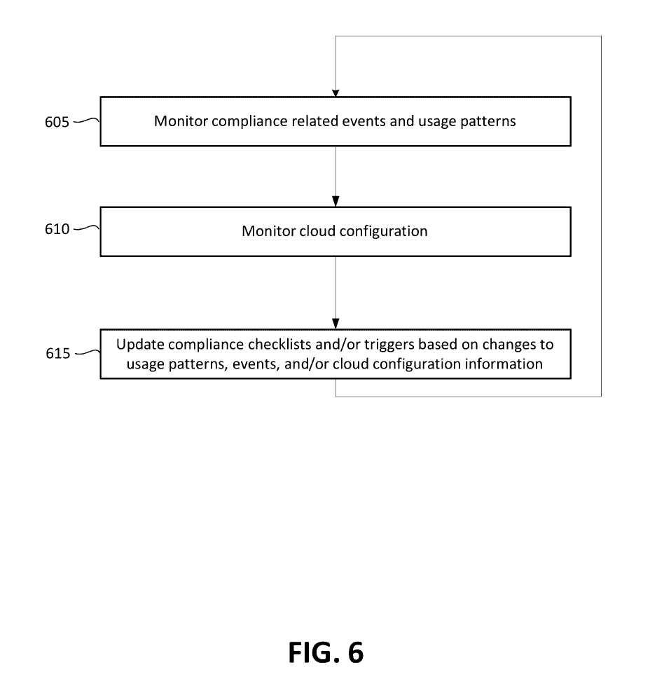

FIG. 6 shows an example flowchart for updating compliance checklists and triggers based on changes to usage patterns and/or cloud configuration information in accordance with aspects of the present invention. The steps of FIG. 6 may be implemented in the environment of FIGS. 1-3, for example, and are described using reference numbers of elements depicted in FIGS. 1-3. As noted above, the flowchart illustrates the architecture, functionality, and operation of possible implementations of systems, methods, and computer program products according to various embodiments of the present invention.

At step 605, compliance related events and usage patterns are monitored. For example, the compliance server 210 may monitor the compliance related events and usage patterns in a similar manner as described above with respect to step 505 in FIG. 5.

At step 610, cloud configuration is monitored. In embodiments, the compliance server 210 may monitor the cloud configuration (e.g., authorized users of an endpoint, applications implemented by the endpoint, resources allocated to the endpoint, etc.) using an API to periodically or intermittently request updated configuration information (e.g., at intervals defined by an administrator or by compliance services). Alternatively, the API may receive push notifications indicating updates to the cloud configuration.

At step 615, compliance checklists and/or triggers are updated based on changes to usage patterns, events, and/or cloud configuration information. For example, as changes are made to the endpoint (e.g., as authorized users, applications, etc. are added and deleted, or as resources are resized for the endpoint), the checklist and triggers may be updated based on changes. For example, compliance checks may be added to the checklist when for newly installed applications, or deleted from the checklist for recently deleted applications. As another example, compliance checks may be added to the checklist for newly allocated resources (e.g., storage, memory, etc.). Also, triggers may be updated based on policies associated with the added or removed compliance checks.

Further, based on event information, the checklists may be updated to add or remove compliance checks. As an illustrative example, event information may indicate that an active virus has been detected on a particular application. For example, blog posts, virus definitions, logs, and/or other event information may indicate that other users/administrators have encountered the virus. Based on this information, a checklist may be updated to add a virus check for the application to the checklist. Further, an event trigger may initiate the compliance check based on the event information indicating that an active virus has been detected.

In embodiments, the checklist may be modified based on usage patterns and trends. For example, the checklists may define a priority and/or schedule that identifies which compliance checks to perform at particular times. Information regarding the usage patterns and trends may be used to modify the checklist based on when various applications implemented by an endpoint are used. In embodiments, usage patterns and trends may trigger compliance checks.

The process of FIG. 6 may repeat as updated configuration information, usage pattern information, and event information is received. As a result, the compliance checklists and triggers are continuously maintained.

In some embodiments, the compliance server 210 may request changes to a cloud ecosystem to better handle compliance actions and checks. For example, the compliance server 210 may delay a deploy request of a VM or change the migration patterns for load balancing resources. In embodiments, the compliance server 210 may predict trends, such as tear down or scaling up of tasks on the environment and delay or speed up the orders/priority of actions, such as compliance actions requested. Advantageously, compliance checks and other compliance actions can be performed before a change within the cloud environment occurs, and before triggers are detected.

In embodiments, a service provider, such as a Solution Integrator, could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method for optimizing cloud compliance services based on compliance actions, via a network. In this case, a computer infrastructure, such as computer system 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
monitoring, by a computing device, compliance-related event information by periodically or intermittently receiving the compliance-related event information via an application programming interface (API) of the computing device;
detecting, by the computing device, an event trigger of a plurality of event triggers based on monitoring the compliance-related event information;
performing, by the computing device, a compliance check, in accordance with a compliance checklist, on an endpoint associated with a cloud network based on detecting the event trigger;
receiving, by the computing device, results to the compliance check; and
updating, by the computing device, the compliance checklist based on the results of the compliance check.

2. The method of claim 1, further comprising updating one or more of the plurality of event triggers based on receiving the results to the compliance check.

3. The method of claim 1, further comprising:
receiving, via the API, compliance check criteria identifying compliance checks for the endpoint; and
defining the compliance checklist identifying the compliance checks to perform on the endpoint,
wherein performing the compliance check is based on defining the compliance checklist.

4. The method of claim 3, further comprising defining, by the computing device, the plurality of event triggers based on receiving the compliance check criteria, wherein detecting the event trigger is based on defining the plurality of event triggers.

5. The method of claim 1, wherein the compliance-related event information includes at least one of:
message board postings;
virus definition alerts,
security alerts; and
software manufacturer update reports.

6. The method of claim 1, further comprising monitoring usage patterns on the endpoint by periodically or intermittently receiving information regarding the usage patterns via an the API, wherein detecting the event trigger is based on monitoring the usage information.

7. The method of claim 6, wherein the information regarding usage patterns include at least one of:
information from usage logs;
updates to settings on the endpoint; and
application usage patterns of applications implemented by the endpoint.

8. The method of claim 1, further comprising detecting a time trigger, wherein performing the compliance check is based on detecting the time trigger.

9. The method of claim 8, further comprising updating the time trigger based on the results of the compliance check.

10. The method of claim 1, wherein the results of the compliance check include at least one of:
entities or areas of the endpoint that were checked;
whether the entities or areas were compliant or non-compliant; and
types of checks performed.

11. The method of claim 1, further comprising receiving updates to configuration information identifying entities implemented by the endpoint, wherein updating the checklist is based on receiving the updates to the configuration information.

12. The method of claim 1, wherein a service provider at least one of creates, maintains, deploys and supports the computing device.

13. The method of claim 1, wherein steps of claim 1 are provided by a service provider on a subscription, advertising, and/or fee basis.

14. The method of claim 1, wherein the computing device includes software provided as a service in a cloud environment.

15. The method of claim 1, further comprising deploying a system for optimizing compliance check services, comprising providing a computer infrastructure operable to perform the steps of claim 1.

16. A computer program product for optimizing compliance check services, the computer program product comprising a computer readable storage medium having program instructions embodied therewith, the program instructions executable by a computing device to cause the computing device to:
monitor compliance-related event information by periodically or intermittently receiving the compliance-related event information via an application programming interface (API) of the computing device;
detect an event trigger of a plurality of event triggers based on monitoring the compliance-related event information;
perform a compliance check, in accordance with a compliance checklist, on an endpoint associated with a cloud network based on detecting the event trigger;
receive results to the compliance check; and
update one or more of the plurality of event triggers based on the results of the compliance check.

17. The computer program product of claim 16, wherein the compliance-related event information includes at least one of:
message board postings;
virus definition alerts,
security alerts; and
software manufacturer update reports.

18. The computer program product of claim 16, wherein the program instructions further cause the computing device to update the compliance checklist based on the results of the compliance check.

19. A system comprising:
a CPU, a computer readable memory and a computer readable storage medium associated with a computing device;
program instructions to monitor compliance-related event information by periodically or intermittently receiving the compliance-related event information via an application programming interface (API) of the computing device;
program instructions to detect a time trigger of a plurality of time triggers, or an event trigger of a plurality of event triggers based on monitoring the compliance-related event information;
program instructions to perform a compliance check, in accordance with a compliance checklist, on an endpoint associated with a cloud network based on detecting the time trigger or the event trigger;
program instructions to receive results to the compliance check;
program instructions to update the compliance checklist based on the results of the compliance check;
program instructions to update one or more of the plurality of time triggers based on the results of the compliance check; and
program instructions to update one or more of the plurality of event triggers based on the results of the compliance check,
wherein the program instructions are stored on the computer readable storage medium for execution by the CPU via the computer readable memory.

20. The system of claim 19, further comprising program instructions to monitor usage patterns or cloud configuration of the endpoint by periodically or intermittently receiving information regarding the usage patterns or the cloud configuration via an the API, wherein detecting the event trigger is based on monitoring the usage information.
